(19) United States
(12) Patent Application Publication
(10) Pub. No.: US 2013/0055311 A1
(43) Pub. Date: Feb. 28, 2013

(54) On Screen Display Content with Information on Stored Content Service Features

(71) Applicants: Morgan Hayden Kirby, Palmer Lake, CO (US); Kristen Leigh Swanson, Denver, CO (US); Karen Taxier, Highlands Ranch, CO (US); Neil Thomas Marten, Denver, CO (US); Luke VanDuyn, Highlands Ranch, CO (US); Tony Nguyen, Aurora, CO (US)

(72) Inventors: Morgan Hayden Kirby, Palmer Lake, CO (US); Kristen Leigh Swanson, Denver, CO (US); Karen Taxier, Highlands Ranch, CO (US); Neil Thomas Marten, Denver, CO (US); Luke VanDuyn, Highlands Ranch, CO (US); Tony Nguyen, Aurora, CO (US)

(73) Assignee: EchoStar Technologies L.L.C., Englewood, CO (US)

(21) Appl. No.: 13/288,002

(22) Filed: Nov. 2, 2011

Related U.S. Application Data
(60) Provisional application No. 61/526,386, filed on Aug. 23, 2011.

(51) Int. Cl. H04N 21/482

(52) U.S. Cl. 725/44

(57) ABSTRACT

A method and system incorporate information on a stored content service feature with on screen display content utilizing a content receiver. The stored content service feature enables the content receiver to simultaneously record multiple of instances of content for a plurality of programming channels during a timeframe. The content receiver generates on screen display content as an overlay to live or previously recorded instances of content or as an electronic programming guide, and the information for the stored content service feature incorporated within the on screen display content may be selected. In response to the selection, the content receiver may transmit a previously recorded instance of content from the plurality of simultaneously recorded instances of content, information for instances of content that have been, will be and/or are available to be recorded in connection with the stored content service feature.

### CROSS REFERENCE TO RELATED APPLICATION

The present application claims the benefit under 35 U.S.C. §119(e) of U.S. Provisional Patent Application No. 61/526,386, which was filed on Aug. 23, 2011, and entitled “On Screen Display Content with Information on Stored Content Service Features,” which is incorporated by reference into the present application in its entirety.

### FIELD OF THE INVENTION

This disclosure relates to utilizing content receivers to provide on screen display content such as electronic programming guides that combine stored content service features with other on screen display content such as content provider schedule information.

### SUMMARY

The present disclosure discloses systems and methods for providing information about a stored content service feature as on screen display content. The stored content service feature may be implemented by a content receiver and may involve the content receiver implementing a service for recording multiple instances of content for multiple programming channels simultaneously and storing the recorded data within a data storage unit of the content receiver for subsequent playback. The channels and timeframe recorded utilizing the stored content service feature may be defined by the content provider. The content receiver may implement the stored content service feature automatically or upon user enrollment. A user viewing a content display device (such as a television) may view information about the stored content service feature within on screen display content such as within an electronic programming guide. The user may select the information on the displayed stored content service feature in order to view previously recorded instances of content stored within the content receiver or programming information for instances of content that have been, will be and/or are available to be recorded and stored within the content receiver, to view enrollment options for causing the content receiver to implement the stored content service feature, and so on.

In one implementation, a method for incorporating a stored content service feature with on screen display content utilizing a content receiver involves generating on screen display content includes programming information for at least one instance of content; incorporating information on the stored content service feature within the on screen display content, the stored content service feature enabling the content receiver to record multiple instances of content simultaneously from a plurality of programming channels; transmitting the on screen display content with the information on the stored content service feature incorporated therein to a content display device; and receiving selections associated with the information for the stored content service feature. In response to receiving the selections, transmitting to the content display device one or more of: a previously recorded instance of content stored within the content receiver, programming information for at least one instance of content previously recorded and stored within the content receiver, programming information for at least one instance of content to be recorded and stored within the content receiver, and programming information for at least one instance of content available to be recorded and stored within the content receiver.

In another implementation, a system for incorporating a stored content service feature with on screen display content includes a content receiver with a processing unit for generating on screen display content including programming information for at least one instance of content and for incorporating information on the stored content service feature within the on screen display content, the stored content service feature enabling the content receiver to record multiple instances of content simultaneously from a plurality of programming channels; a memory unit configured to store a plurality of instances of content; and a communications unit for transmitting the on screen display content with the information on the stored content service feature incorporated therein to a content display device. The communications unit receives selections associated with the information for the stored content service feature, and in response to receiving the selections, the processing unit transmits to the content display device one or more of: a previously recorded instance of content stored within the processing unit, programming information for at least one instance of content previously recorded and stored within the processing unit, programming information for at least one instance of content to be recorded and stored within the processing unit, and programming information for at least one instance of content available to be recorded and stored within the processing unit.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for automatically recording multiple instances of content from one or more programming providers.

FIG. 2 is a block diagram illustrating a system for providing on screen display content that includes stored content service features.

FIG. 3A is a flow chart illustrating a method for providing electronic programming guides that combine stored content service features with content provider schedule information. This method may be performed by the system of FIG. 2.

FIG. 3B is a flow chart illustrating a method for providing on screen display content that includes stored content service features. This method may be performed by the system of FIG. 2.

FIGS. 4A-4D are diagrams illustrating on screen display content that may be provided by the system of FIG. 2.

### DETAILED DESCRIPTION OF THE EMBODIMENTS

The description that follows includes sample systems, methods, and computer program products that embody various elements of the present disclosure. However, it should be understood that the described disclosure may be practiced in a variety of forms in addition to those described herein.

Users of content receivers may desire to access different instances of content that are broadcast simultaneously and/or substantially contemporaneously by content providers. For example, many television programming viewers wish to watch different television programs that occupy the same broadcast time slot, such as the different television programs associated with the major television programs that are broadcast between seven PM and ten PM mountain time. Content receivers may attempt to address this issue by utilizing multiple tuners that can each separately present and/or record different, simultaneously broadcast instances of content. However, a separate tuner may still be required for each simultaneous or substantially contemporaneous instance of broadcast or otherwise received content that a content receiver user wishes to view and/or record. Further, in addition to separate tuners required for each instance of content, the content receiver may require sufficient resources to descramble and store each of the instances of content desired by the user.

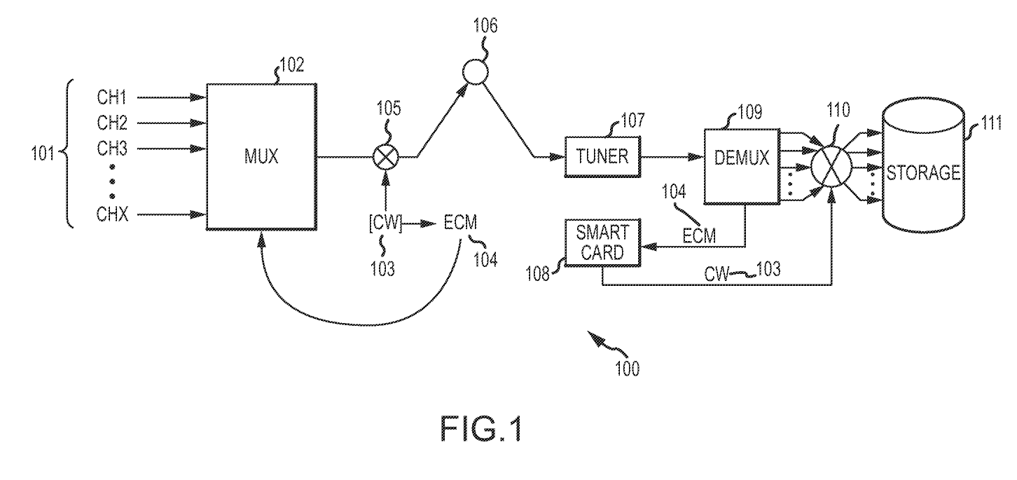

FIG. 1 is a block diagram illustrating a system 100 for automatically recording multiple instances of content from one or more programming providers. The automatic recording of multiple instances of content provided by the system 100 may enable users of content receivers to access different instances of content that are broadcast simultaneously and/or substantially contemporaneously by content providers.

In various broadcast systems, content providers may broadcast content to a plurality of different content receivers via one or more frequency bands utilizing one or more satellites. Each multiplexed signal contained in the frequency band (sometimes referred to as a transponder) may be configured to include data related to one or more instances of content, such as one or more television programming channels. The data related to each of the instances of content included in each frequency may be scrambled utilizing one or more CWs (control words), which may then be encrypted to generate one or more ECMs (entitlement control messages) which may in turn be included with the data. A content receiver may typically tune to one or more of the frequency bands to receive the multiplexed signal that contains data for a particular programming channel utilizing one or more tuners. The content receiver may process only a subset of the programming channels by keeping the data associated with the particular programming channel and discarding data received via the tuned frequency band and multiplexed signal associated with other programming channels. The content receiver may decrypt the ECM included with the data associated with the particular programming channel to obtain the CW, descramble the data utilizing the CW, and store and/or transmit the data (e.g., decompressed, reconstructed audio and video data) to one or more presentation devices.

As illustrated in FIG. 1, in this implementation, one or more content providers may select multiple instances of content 101 to be automatically recorded such as by utilizing predefined recording parameters. For example, a content provider may select all of the television events defined as “primetime events” associated with all channels defined as “primetime television channels” for a particular period of time defined as “prime time” to be automatically recorded. In other examples, the content provider may select television events associated with programming channels for a particular time period (such as a half hour, multiple hours, and/or an entire programming day) in response to user selections. After the content provider selects the multiple instances of content, the multiple instances of content may be multiplexed utilizing a multiplexer 102. The multiplexed signal (which includes the multiplexed selected multiple instances of content) may then be scrambled by a scrambler 105 utilizing one or more CWs 103. The CW may be encrypted to generate an ECM, which may be included with the multiplexed signal. The scrambled multiplexed signal may then be included in a broadcast on a frequency band (e.g., cable, satellite), which may then be transmitted to one or more satellites 106 for broadcast. The satellite 106 may receive the frequency band (uplink frequency band) and then broadcast the multiplexed signal to a number of content receivers on a translated frequency band (downlink frequency band), such as a content receiver that includes a tuner 107.

The tuner 107 may tune to the frequency band that includes the multiple instances of content (which may be performed in response to one or more recording instructions received by the content receiver that includes the tuner from the content provider). The data received via the tuned frequency may be demultiplexed by a demultiplexer 109 and then descrambled by a descrambler 110 utilizing the CW before being stored in a non-transitory storage medium 111 (which may take the form of, but is not limited to, a magnetic storage medium; optical storage medium; magneto-optical storage medium; read only memory; random access memory; erasable programmable memory; flash memory; and so on) based on recording parameters, such as predefined recording parameters. The demultiplexer 109 may obtain the included ECM 104, and the ECM may be provided to a smart card 108 that may decrypt the ECM 104 to obtain the CW 103 for the descrambler 110. Hence, the multiple instances of content may subsequently all be available to a user of the content receiver (until such time as they are removed from the non-transitory storage medium) without requiring multiple tuners to receive each of the multiple instances of content, without requiring the smart card to decrypt multiple ECMs. In some implementations, the multiple instances of content may be stored in a single file.

Although the system 100 is illustrated in FIG. 1 and described above as including a number of specific components configured in a specific arrangement, it is understood that this is for the purposes of example and other arrangements involving fewer and/or additional components are possible without departing from the scope of the present disclosure. For example, in various implementations, the multiple instances of content may be individually scrambled utilizing the control word prior to multiplexing. In another example, in some implementations, the data received via the tuned frequency may be demultiplexed before being individually descrambled utilizing the control word.

Electronic programming guides (EPG) generated by content receivers generally include a collection of programming details identifying instances of content for the various programming channels supported by the content stream. The EPG may be a grid or table of timeframes (x-axis) and programming channels (y-axis) and blocks within the grid with programming information identifying instances of content (such as show titles for television shows). The programming information may generally be alpha-numeric symbols identifying the instances of content. When the user desires to view past, present or future programming information, the user generally enters a selection from a controller (such as a remote control) that generates a command for the content receiver to transmit the EPG to the content display device. The user may scroll through the grid of programming information and select an instance of content of interest. For example, the content receiver may transmit an image of a cursor or a highlighted overlay (e.g., having a different color or shade compared to the EPG background) that may be used as a navigation and selection tool. Navigating to a block showing the programming information enables the user to select the block, and depending on the type of selection entered, the content receiver generally takes some action. For example, the content receiver may change the channel to the instance of content associated with the programming information identified in the EPG, transmit programming details on the instance of content (such as date, time, duration, synopsis, and the like) to the content display device, transmit a confirmation about the user's selection, such as a confirmation that the selected programming event is to be recorded, and so on.

However, in view of the functionality of the system of FIG. 1 in which multiple instances of content are recorded simultaneously and stored in the non-transitory storage medium 111 of the content receiver, there is a need to provide on screen display content such as an EPG that highlights the information on the stored content service feature described above in which multiple instances of content are available for recording, have been recorded and are available for viewing, or both.

Accordingly, the present disclosure discloses systems and methods for providing on screen display content such as an EPG or otherwise that includes information on the stored content service feature. When provided in connection with an EPG, the information on the stored content service feature is incorporated with content provider scheduling information. For example, the EPG may include information on the stored content service feature that directs the user to previously recorded instances of content, that notifies the user that upcoming instances of content that are to be recorded for specified channels during a timeframe and/or that instructs or informs the user about the availability to enroll the user's account to cause the content receiver to implement the stored content service feature. When provided in connection with other on screen display content, the information on the stored content service feature may be provided as an overlay to video content or to other on screen display content.

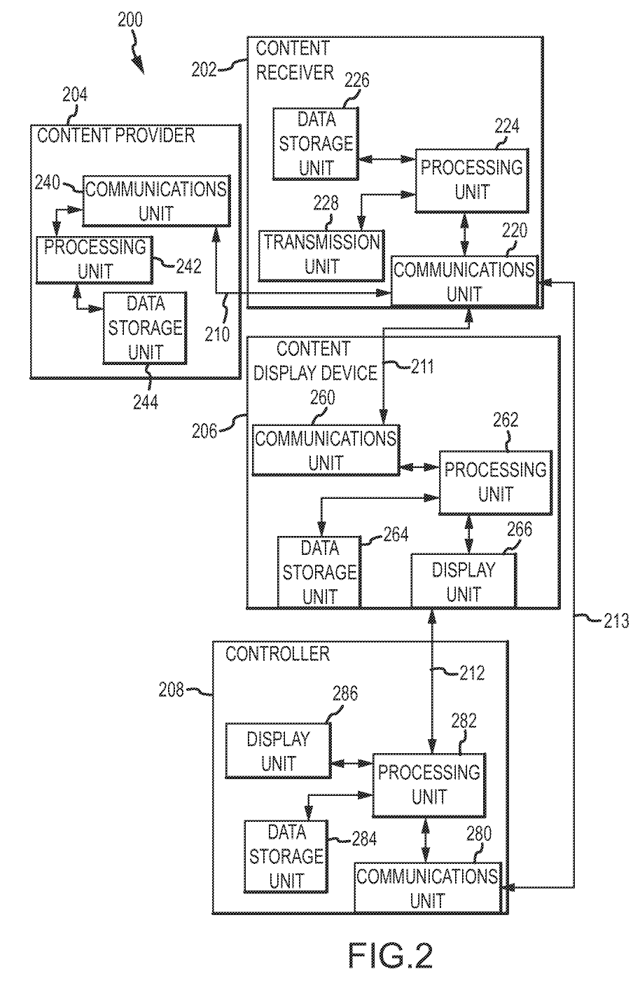

FIG. 2 is a block diagram illustrating a system 200 for providing on screen display content such as an EPG or otherwise that includes information on the stored content service feature. The system 200 may be at least partly incorporated into the system of FIG. 1. The system 200 includes a content receiver 202 (such as a set top box) for receiving and transmitting content (such as television programming and on screen display content), a content provider 204 for transmitting the content (such as a satellite or cable programming service provider), a content display device 206 for receiving and displaying the content (such as a television), and a controller 208 (such as a remote control) for transmitting data such as control signals to the content receiver 202.

The content receiver 202 is a device for receiving content from the content provider 204 and other external sources, for processing or decoding the content and for transmitting the content to the content display device 206. The content receiver 202 is, for example, a set top box, a television receiver, a digital video recorder, a computing device, a gaming device, or a television, which is generally located at a user's location (such as a user's residence or business). The content receiver 202 is operable to receive content from the content provider 204 (and/or another external source) by way of the transmission link 210. Such content is received by the communications unit 220 of the content receiver 202. The data from the content provider 204 may be provided to the processing unit 224 for executing instructions stored in the data storage unit 226 (such as the non-transitory storage medium 111) and for providing content to the content display device 206 and/or audio speakers via the transmission unit 228. The transmission unit 228 may be communicatively coupled to the content display device 206 by way of the processing unit 224, the communications unit 220 and the transmission link 211. In some implementations the processing unit 224 implements the stored content service feature by simultaneously recording and storing multiple instances of content in the memory unit 226. The multiple instances of content may be subsequently available to a user of the content receiver 202 without requiring multiple tuners to receive each of the multiple instances of content, without requiring the smart card 103 to decrypt multiple ECMs, and/or without requiring the combiner 109 to have to descramble multiple signals as described above in connection with the system of FIG. 1. The processing unit 224 may be configured to execute instructions stored in the data storage unit 226 for activating recording features, for recording content including recording multiple instances of content simultaneously for a number of programming channels over a timeframe, for managing recorded content and upcoming content to be recorded, and for generating on screen display content such as an EPG or otherwise that incorporates information identifying the stored content service feature.

The content provider 204 (such as a satellite programming company, a cable company, an Internet service provider, e.g., an online video service or Internet video provider, and the like) is generally remotely located from the content receiver 202. The content provider 204 utilizes a communications unit 240, a processing unit 242 and a data storage unit 244 to receive, manage and store content, which is transmitted as content by the communications unit 240 to the communications unit 220 of the content receiver 202 via the transmission link 210. The content provider 204 may transmit metadata to the content receiver 202 that may include data instructing the content receiver 202 to automatically record multiple instances of content simultaneously.

The content display device 206 is generally arranged proximate to and is communicatively coupled to the content receiver 202 and displays content transmitted by the content receiver 202. While the content display device 206 and the content receiver 202 are depicted as separate components in FIG. 2, the content receiver 202 may be incorporated with the content display device 206. The content display device 206 is, for example, a television, a computer screen, a video screen, or any other display device for displaying content. The content display device 206 includes a communications unit 260, which receives content from the communications unit 220 of the content receiver 202 by way of the transmission link 211. The content display device 206 also includes a processing unit 262 for executing instructions stored in a data storage unit 264, and a display unit 266 for displaying the content received from the content receiver 202 such as on screen display content.

The controller 208 is generally provided in an area proximate the content receiver 202 and is communicatively coupled to the content display device 206 by way of the transmission link 212, and to the content receiver 202 by way of the transmission link 213. The controller 208 is, for example, a remote control, such as a universal remote control, a dedicated remote control, or a computing device programmed to send command signals (such as selection signals) to the content receiver 202. The controller 208 includes a communications unit 280 for sending and receiving information, a processing unit 282 for executing instructions stored in a data storage unit 284, and an optional display unit 286 for presenting information stored within the data storage unit 284 such as information related to a command sent to the content receiver 202.

Returning to the content receiver 202, the processing unit 224 may be programmed to dynamically configure on screen display content, such as an EPG, to incorporate information informing the user about the availability or status of the stored content service feature. The data for informing the user of the stored content service feature may be stored in the memory unit 226 and may be accessible to the processing unit 224. The processing unit 224 may generate the EPG with the information on the stored content service feature incorporated therein as a selectable item such as a selectable block. For example, in some implementations, upon the user selecting the information on the stored content service feature from the on screen display (such as by utilizing the controller 208), the processing unit 224 may generate and the communications unit 220 may transmit a previously recorded instance of content stored within the content receiver, programming information for at least one instance of content previously recorded and stored within the content receiver, programming information for at least one instance of content to be recorded and stored within the content receiver, and/or programming information for at least one instance of content available to be recorded and stored within the content receiver. It will be appreciated that the previously recorded instance of content and the programming information described above may each be associated with the stored content service feature described above. This is in contrast to other instances of content recorded based on user selections of individual instances of content to be recorded, and is in contrast to programming information unrelated to the stored content service feature that may be generated by the content receiver in connection with an EPG or other forms of on screen display content.

In some implementations, upon selecting the selectable block, the processing unit 224 may transmit an enrollment screen to the content display device 206 prompting the user to enroll the user's account in the stored content service feature. In response to the user entering enrollment selections, the processing unit 224 may activate the stored content service feature and the processing unit 224 may record multiple instances of content.

In some implementations, the processing unit 224 of the content receiver 202 may dynamically configure an EPG to include information directing the user to previously recorded instances of content and/or may notify the user that upcoming instances of content that are to be recorded for specified channels during a timeframe. The data for informing the user of the stored content service feature may be stored in the memory unit 226 accessible to the processing unit 224. The processing unit 224 may generate the EPG with the stored content service feature incorporated therein as a selectable block. In some implementations, upon selecting the selectable block (such as by utilizing the controller 208), the processing unit 224 may generate and instruct the processing unit 220 to transmit a listing of recorded instances of content available for the user to view and/or a listing of instances of content that are to be recorded for the user to view sometime in the future.

In some implementations, the processing unit 224 may be programmed to dynamically configure on screen display content as an overlay that incorporates information on the stored content service feature. The information identifying the stored content service feature may be transmitted to the content display device 206 as an overlay to video content, for example. The user may thus view the stored content service feature while simultaneously viewing live or previously recorded video content. In some implementations, the stored content service feature may be displayed as an overlay to video content for a predefined period of time, such as 3 seconds, and may disappear from the content display unit unless an action is taken in connection with the information displayed.

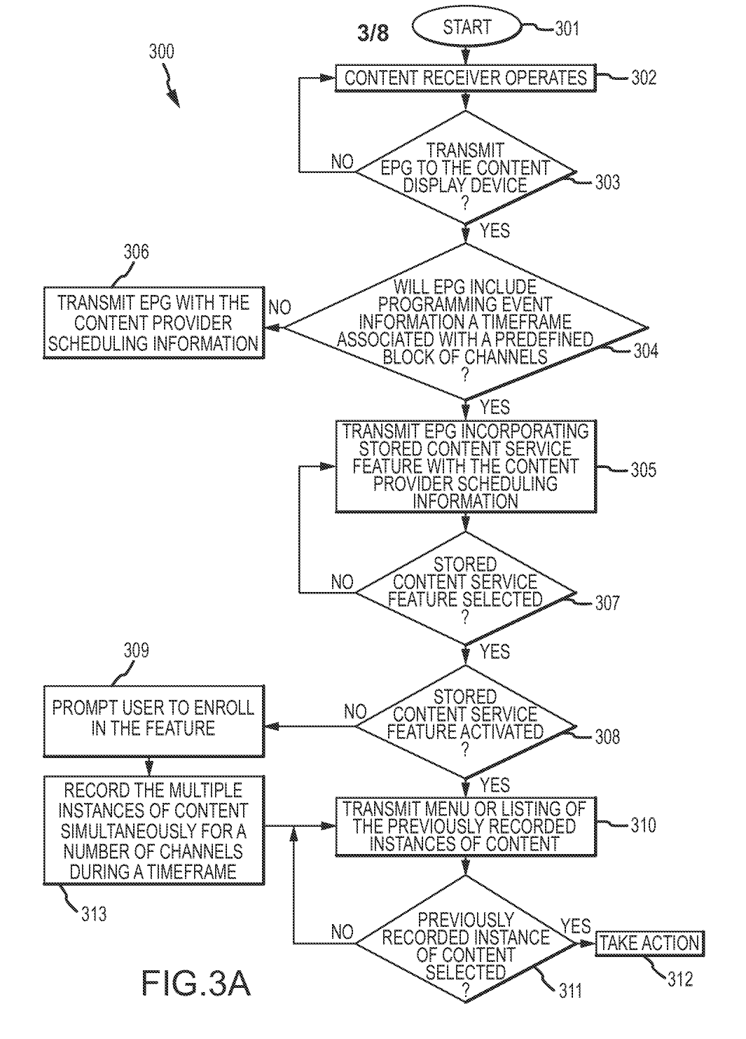

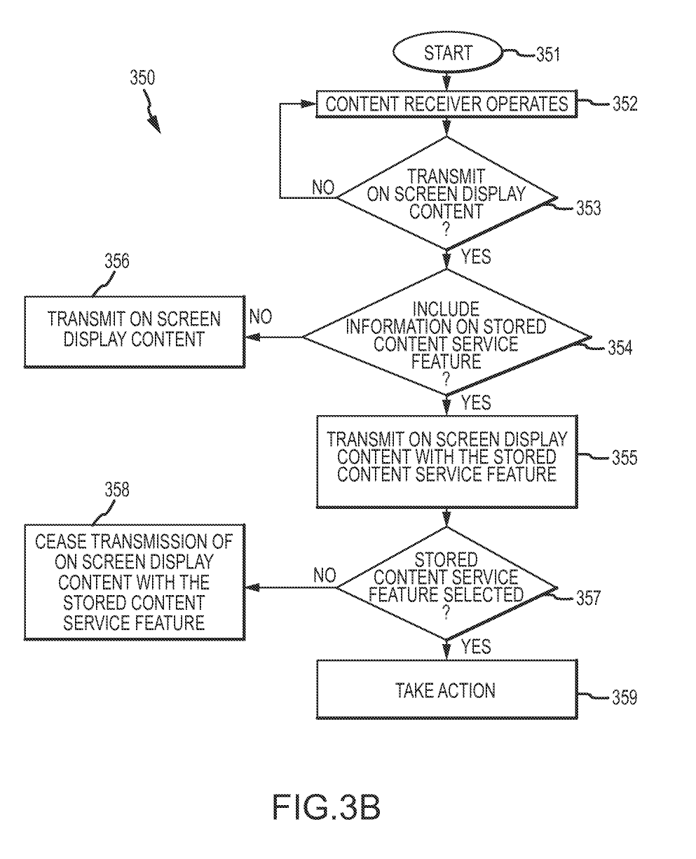

FIG. 3A illustrates a method 300 for generating an EPG incorporating the stored content service feature with content provider scheduling information utilizing a content receiver. The method 300 may be performed by the systems 100 and 200 of FIGS. 1 and 2. The flow begins at block 301 and proceeds to block 302 where the content receiver operates. The flow then proceeds to block 303 where the processing unit 224 determines whether an EPG is to be transmitted to the content display device 206. If not, the flow returns to block 302. If so, the flow then proceeds to block 304 where the processing unit 224 optionally determines whether the EPG will include programming event information for a timeframe associated with a predefined block of channels. If so, the flow proceeds to block 305 where the processing unit 224 transmits an EPG to the content display device 206 that incorporates information on the stored content service feature. If not, the flow proceeds to block 306 where the processing unit 224 transmits an EPG to the content display device 206 without the information on the stored content service feature.

In some implementations, the flow optionally proceeds directly from block 303 to block 305. That is, in response to the processing unit 224 determining the EPG is to be transmitted to the content display device from block 303, the flow may then proceed to block 305 where the processing unit 224 transmits an EPG to the content display device 206 that incorporates stored content service feature within the EPG regardless of the timeframe or channels associated with the EPG described in connection with block 304.

In some implementations, the flow continues to block 307 where the processing unit 224 determines whether a selection of the stored content service feature displayed within the EPG has been made. If not, the flow returns back to block 206 in which the information on the stored content service feature is displayed within the EPG. If so, the flow optionally proceeds to block 308 where the processing unit 224 determines whether the stored content service feature has been activated within the content receiver 202. This operation may involve the processing unit 224 checking whether multiple instances of content have previously been recorded simultaneously for a predefined number of channels. If the stored content service feature has not been activated, the flow proceeds to block 309 where the processing unit 224 prompts the user to enroll in the stored content service feature (such as by instructing the user to call their content provider or by utilizing the controller 208 to enter selections confirming the content receiver 202 is to record the multiple instances of content simultaneously for a number of channels). If activated, the flow proceeds to block 310 where the processing unit 224 transmits a menu or listing of the previously recorded instances of content to the content display device 206. The flow may then proceed to block 311 where the processing unit 224 determines whether a selection from the listing of previously recorded instance of content has been entered. If not, the flow proceeds back to block 310 where the menu of previously recorded instances of content is displayed. If a selection has been entered, the flow proceeds to block 312 where the processing unit 224 takes action (such as playing the instance of content selected, displaying programming details for the instance of content selected, displaying a listing of a the number of instances of content (e.g., episodes) for the selected instance of content, and so on.

Returning to block 309, upon enrolling in the stored content service feature, the flow may proceed to block 313 where the processing unit 224 records the multiple instances of content simultaneously for a number of channels during a timeframe. The flow may then proceed back to block 310 where the user may select from a menu or listing of the previously recorded instances of content described above.

FIG. 3B illustrates a method 350 for generating on screen display content including information on the stored content service feature utilizing a content receiver. The method 350 may be performed by the systems 100 and 200 of FIGS. 1 and 2. The flow begins at block 351 and proceeds to block 352 where the content receiver operates. The flow then proceeds to block 353 where the processing unit 224 determines whether the on screen display content is to be transmitted to the content display device 206. The on screen display content may be an overlay to video content, for example. If not, the flow returns to block 352. If the on screen display content is transmitted, the flow then proceeds to block 354 where the processing unit 224 optionally determines whether the on screen display content will include the information on the stored content service feature. If so, the flow proceeds to block 355 where the processing unit 224 transmits on screen display content to the content display device 206 that includes the information on the stored content service feature. If not, the flow proceeds to block 356 where the processing unit 224 transmits on screen display content. However, in some implementations, the processing unit 224 transmits an the on screen display content with the information on the stored content service feature in each instance, thereby omitting blocks 354 and 355 from the method 350.

From block 356, the flow then proceeds to block 357 where the processing unit 224 determines whether the stored content service feature has been selected (such as by utilizing controller 208). If not, the flow proceeds to block 358 where the processing unit 224 ceases to transmit the on screen display content with the stored content service feature. If so, the flow proceeds to block 359 where the processing unit 224 takes some action. For example, the processing unit 224 may take action by checking whether the user has enrolled in the stored content service feature and may prompt the user to enroll if necessary; by displaying a menu of previously recorded instances of content to the content display device 206; by displaying programming details for the instance of content selected; by displaying a listing of a the number of instances of content (e.g., episodes) for the selected instance of content; by playing the previously recorded instance of content selected; and so on.

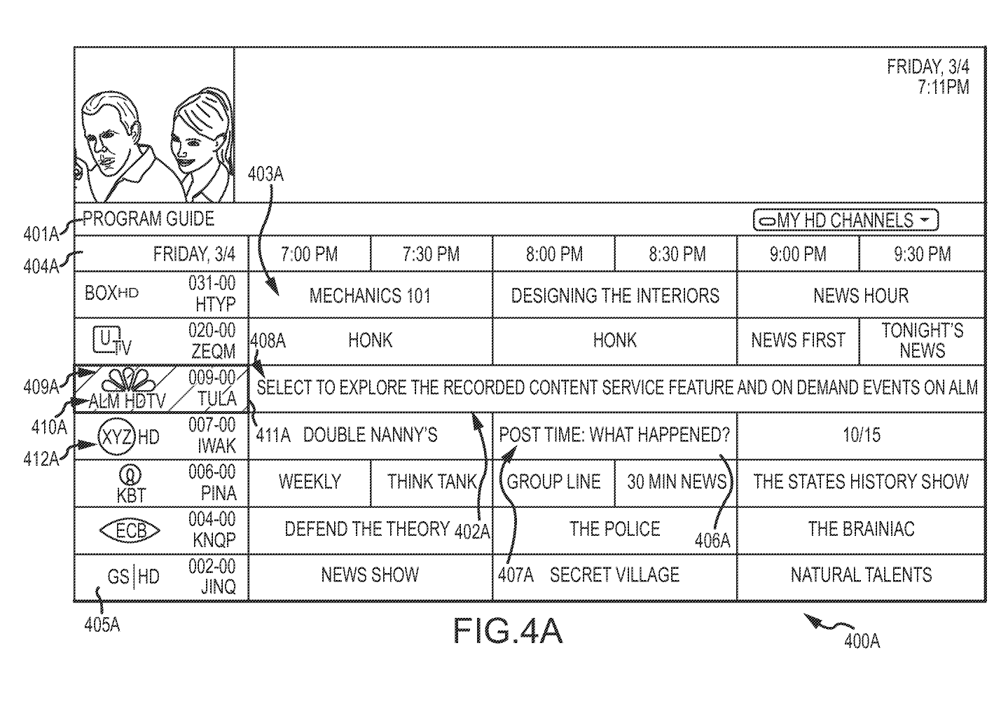

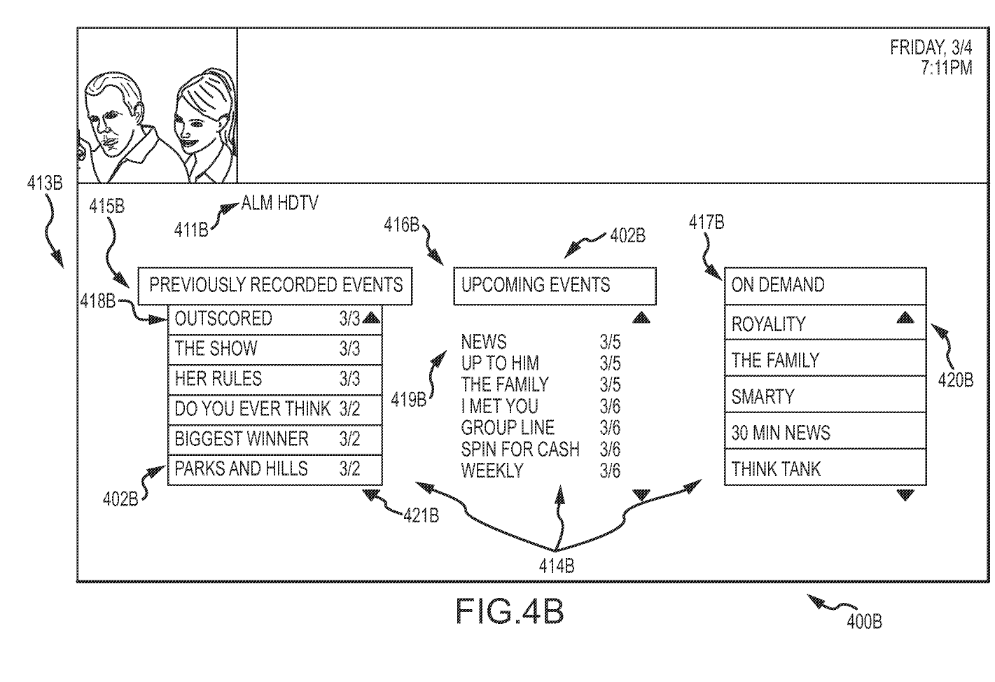

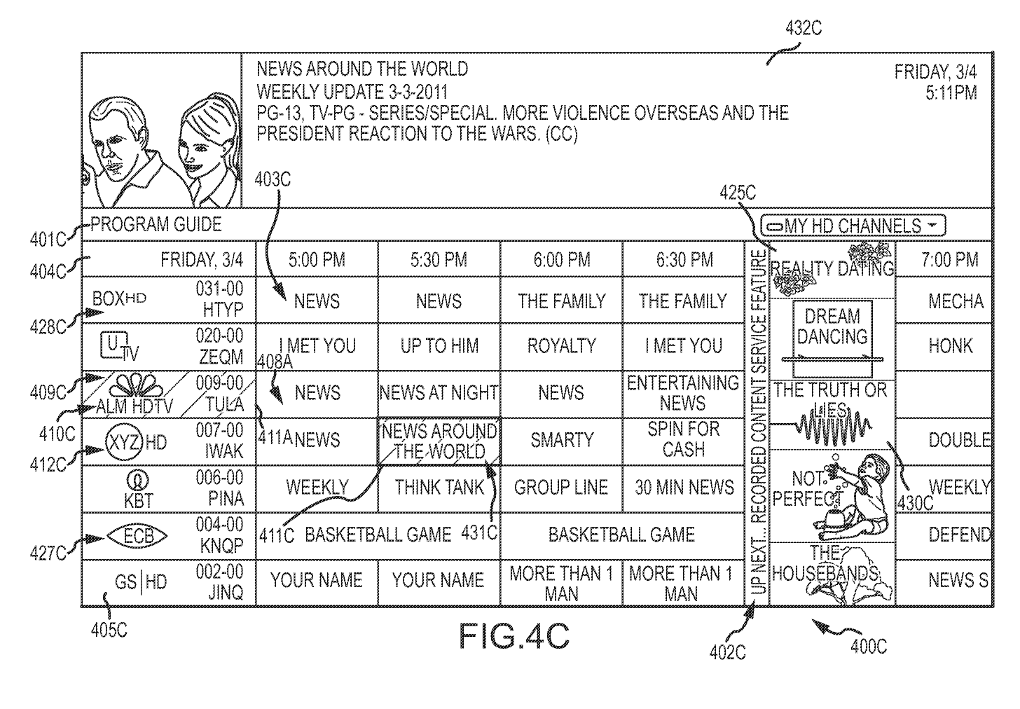

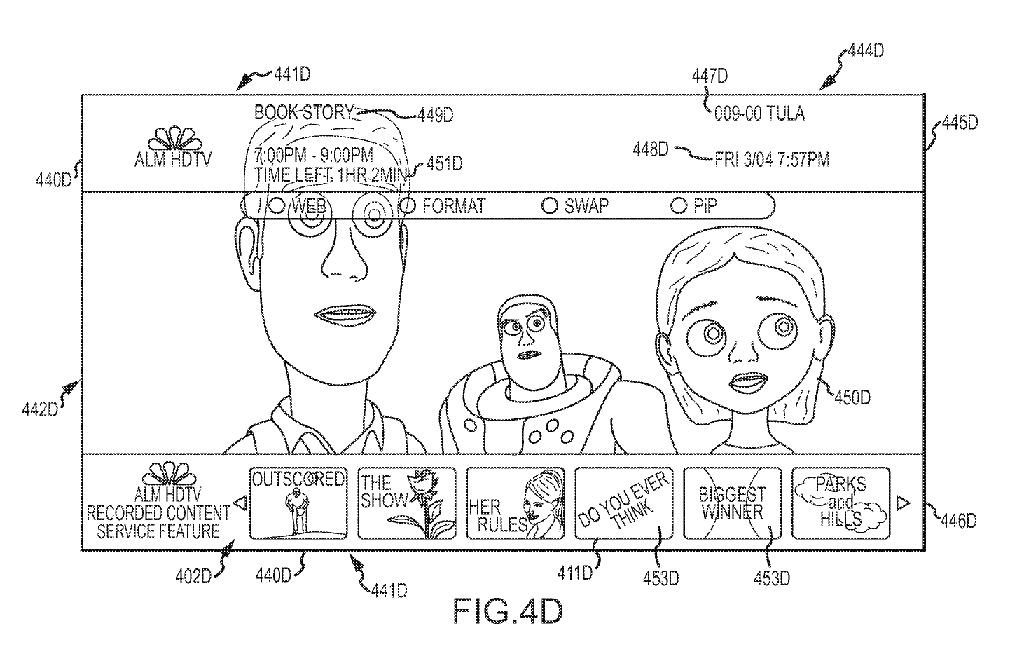

FIGS. 4A-4D are diagrams illustrating implementations for displaying the information on the stored content service feature as a portion of an on screen display, such as an EPG. In FIG. 4A, an EPG 401A incorporates information for the stored content service feature 402A with the content provider scheduling information. The EPG 401A may be generated utilizing the content receiver 202 in the system of FIG. 2. In FIG. 4A, the EPG 401A is composed of a grid 403A with a date/time axis 404A and a channel axis 405A. The grid 403A is composed of a number of blocks 406A identifying content provider scheduling information 407A such as alpha-numeric text identifying instances of content (television shows). According to the implementations provided herein, the grid 403A incorporates information for the stored content service feature 402A by including a prompt or message 408A proximate or adjacent to the channel block 409A (e.g., to the right of the channel block 409A) and the associated channel 410A underlying the cursor 411A. The prompt or message 408A provides the user with information on viewing details related to the information on the stored content service feature 402A. This is in contrast to the content provider scheduling information 407A displayed in the blocks 406A for channels 412A not affected by the cursor 411A. It will be appreciated that upon moving the cursor 411A vertically to another channel, another prompt or message 408A may be displayed for the channels the content receiver 202 is capable of implementing the stored content service feature. Upon moving the cursor 411A to the right, e.g., to an area underlying a time range (such as 8:00 PM to 9:00 PM), the prompt or message 408A may be replaced with blocks 406A identifying content provider scheduling information 407A as shown for the channel 412A.

Turning to FIG. 4B, in response to the user navigating to and selecting the channel block 409A utilizing the cursor 411A, the content receiver 202 may transmit an on screen display 413B identifying a number of menus 414B associated with the stored content service feature including a menu of previously recorded instances of content 415B, a menu of upcoming instance of content to be recorded 416B and/or a menu of on demand instances of content 417B associated with the channel 411B identified and selected from the EPG 401A. The menu of previously recorded instances of content 415B may be provided as a number of selectable items 418B that enables the user to view the recorded instance of content and/or additional details for the instance of content selected. The menu of upcoming instance of content to be recorded 416B may be provided as a listing of items 419B, which may be selectable for viewing additional details for the instance of content. The menu of on demand instances of content 417B may be provided as a number of selectable items 420B for viewing the instance of content, for purchasing the service, and/or for viewing additional details for the instance of content selected. The user may scroll through the various menus 414B utilizing the arrow icons 421B and/or the controller 208. The on screen display 413B of FIG. 4B may include additional menus such as menus identifying previously recorded instances of content having been recorded using traditional recording methods, such as recordings previously selected for recording by the user.

In addition or as an alternative to FIGS. 4A and 4B, in some implementations, the information on the stored content service feature 402A may be provided as a separate item within the grid 403A rather than being associated with the channel block 409A and channel 410A. In this case, the information on the stored content service feature 402A may be associated with one or more channels (e.g., 410A and 412A) for which the content receiver 202 is configured for implementing the stored content service feature. Accordingly, the on screen display 413B may include menus 414B associated with the stored content service feature for such channels. Furthermore, referring back to FIG. 4A, the information on the stored content service feature 402A may be provided in the manner of FIG. 4A, but the on screen display 413B may include menus 414B associated with the stored content service feature 402B for a number of channels.

FIG. 4C illustrates an EPG 401C incorporating information for the stored content service feature 402C with the content provider scheduling information. The EPG 401C may be generated utilizing the content receiver 202 in the system of FIG. 2. In some implementations, the vertically arranged selectable item 425C may be arranged anywhere within the EPG 401C and may provide the user with a visual indication about the availability or operational state of the stored content service feature. In FIG. 4C, the information on the stored content service feature 402C is provided as a vertically arranged selectable item 425C within the grid 403C in a portion of the EPG 401C corresponding to the time preceding the activation of the stored content service feature 402C. For example, the stored content service feature may be associated with the content receiver 202 simultaneously recording the multiple instances of content for channels 410C, 412C, 427C and 428C over a three-hour timeframe from seven PM and ten PM. The vertically arranged selectable item 425C representing the information on the stored content service feature 402C may accordingly precede the three-hour timeframe in the portion of the EPG 401C associated with the channels available to be or that are scheduled to be simultaneously recorded. In some implementations, the vertically arranged selectable item 425C may include pictures 430C identifying one or more instances of content available for recording or scheduled to be recorded. In some implementations, the cursor 411C arrangement may result in the content receiver 202 dynamically modifying the vertically arranged selectable item 425C to include pictures 430C associated with the channel 412C for the instance of content 431C underlying the cursor 411C. The EPG 401C also includes a message box 432C showing details of the instance of content 431C associated with the channel 412C.

FIG. 4D is a diagram illustrating on screen display content 440D including information on the stored content service feature 402D. The on screen display content 440D may be provided as an overlay 441D to video content 442D and may be generated utilizing the content receiver 202 in the system of FIG. 2. The user may navigate to the information on the stored content service feature 402D utilizing the cursor 411D. In FIG. 4D, the on screen display content 440D includes programming information 444D in an upper region 445D and the information on the stored content service feature 402D in a lower region 446D. The upper region 445D includes programming information 444D such as a channel and/or network identifier 447D, a date and/or time field 448D, an identification field 449D identifying the instance of content 450D displayed as the video content 442D, a run and/or remaining time field 451D identifying the run and/or remaining time for the instance of content 450D, and so on. The instance of content 450D displayed as the video content 442D may be live or previously recorded content. In the lower region 446D of the on screen display content 440D, information identifying information on the stored content service feature 402D may be displayed as a series of pictures 453D identifying instances of content that have been or are available to be recorded. While the information on the stored content service feature 402D is provided in a separate, lower overlaying region 446D compared to the upper overlaying region 445D in FIG. 4D, the information on the stored content service feature 402D may be displayed in any region within the on screen display content 440D, alone or in combination with the programming information 444D, and the region may be an overlay 441D to any portion of the video content 442D (such as at a left side, right side, middle, center, upper and/or lower portion).

In FIG. 4D, the cursor 411D overlies a picture 443D, and upon selection of the picture 443D (such as by utilizing the controller 208), the content receiver 202 may take some action such as transmit the instance of content for viewing, transmit an enrollment screen as described above, transmit the on screen display 413B with the menus 414B described above, transmit details about the instance of content, and so on. When the cursor 411D is not utilized in connection with the information on the stored content service feature 402D, the on screen display content 440D may only be temporarily transmitted by the content receiver 202, thereby resulting in the video content 442D being displayed without the overlaying on screed display content 440D after some timeframe (such as 3-5 seconds). It will be appreciated that the on screen display content 440D may be displayed as an overlay to the video content 442D during operations such as changing the programming channel and/or utilizing the controller 208 communicate with the content receiver 202 (e.g., for entering selections), for viewing details related to the instance of content 450D, upon exiting from the EPG 401, and so on. In addition, the information on the stored content service feature 402D may be dynamically modified in response to such operations. For example, in response to changing the programming channel, the pictures 453D identifying instances of content may be updated to identify instances of content delivered by the programming channel being transmitted to the content display device 206. In another example, the programming channel transmitted to the content display device 206 may be affiliated (such as a network affiliate) with a programming channel for which the stored content service feature is active. In this case, the information on the stored content service feature 402D may be dynamically modified based on a programming channel affiliation with another programming channel, and the pictures 453D identifying instances of content may be updated to identify instances of content delivered by the affiliated programming channel.

In some implementations, the information on the stored content service feature 402A, 402C, 402D provided within an EPG 401A, 401C or as on screen display content 440D may be displayed during predefined times and/or channels. For example, the information on the stored content service feature 402A, 402C, 402D may be displayed during a timeframe preceding the simultaneous recording of the multiple channels (such as a preceding 1-5 hours), during the timeframe of the simultaneous recording of the multiple channels, for predefined channels (such as for programming channels the content receiver 202 is capable of implementing the stored content service feature and affiliate programming channels), and combinations thereof. In other implementations, the information on the stored content service feature 402A, 402C, 402D may be displayed at any time and as an overlay to video content for any channel.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method for incorporating information on a stored content service feature with on screen display content utilizing a content receiver, the method comprising:
generating on screen display content comprising programming information for at least one instance of content;
incorporating information on the stored content service feature within the on screen display content, the stored content service feature enabling the content receiver to record multiple instances of content simultaneously from a plurality of programming channels;
transmitting the on screen display content with the information on the stored content service feature incorporated therein to a content display device; and
receiving selections associated with the information for the stored content service feature;
wherein in response to receiving the selections, transmitting to the content display device one or more of: a previously recorded instance of content recorded utilizing the stored content service feature, programming information for at least one instance of content previously recorded utilizing the stored content service feature, programming information for at least one instance of content to be recorded utilizing the stored content service feature, and programming information for at least one instance of content available to be recorded utilizing the stored content service feature.

2. The method of claim 1, wherein the at least one previously recorded instance of content is associated with a plurality of instances of content for a plurality of programming channels previously simultaneously recorded by the content receiver.

3. The method of claim 1, wherein the at least one instance of content to be recorded is associated with a plurality of instances of content for a plurality of programming channels to be simultaneously recorded by the content receiver.

4. The method of claim 1, wherein the at least one instance of content available to be recorded and stored within the content receiver is associated with a plurality of instances of content for a plurality of programming channels available to be simultaneously recorded by the content receiver.

5. The method of claim 1, further comprising utilizing the content receiver to configure the on screen display content as an overlay to content transmitted by the content receiver to the content display device.

6. The method of claim 5, wherein the content transmitted by the content receiver comprises video content for the instance of content.

7. The method of claim 1, wherein the content receiver dynamically modifies the information on the stored content service feature based on receiving selections for one of the plurality of programming channels associated with the stored content service feature.

8. The method of claim 1, further comprising utilizing the content receiver to generate the on screen display content as an electronic programming guide including a grid of a plurality of programming channels and timeframes, and blocks within the grid identifying programming information for a plurality of instances of content, wherein the content receiver incorporates the information on the stored content service feature within the grid.

9. The method of claim 8, wherein the content receiver dynamically modifies the information on the stored content service feature based on receiving selections associated with the electronic programming guide.

10. The method of claim 8, wherein the content receiver transmits the information on the stored content service feature based on the content receiver determining that a timeframe for the electronic programming guide falls within a predefined time range.

11. The method of claim 10, wherein the content receiver transmits the information on the stored content service feature incorporated within the grid based on the content receiver determining that one or more instances of content associated with one or more programming channels within the electronic programming guide are capable of being recorded utilizing the stored content service feature.

12. The method of claim 8, wherein the content receiver transmits the information on the stored content service feature incorporated within the grid based on the content receiver determining that one or more instances of content associated with one or more programming channels within the electronic programming guide are capable of being recorded utilizing the stored content service feature.

13. A system for incorporating a stored content service feature with on screen display content utilizing a content receiver, the content receiver comprising:
a processing unit for generating on screen display content comprising programming information for at least one instance of content and for incorporating information on the stored content service feature within the on screen display content, the stored content service feature enabling the processing unit to record multiple instances of content simultaneously from a plurality of programming channels;
a memory unit configured to store a plurality of instances of content;
a communications unit for transmitting the on screen display content with the information on the stored content service feature incorporated therein to a content display device;
wherein the communications unit receives selections associated with the information for the stored content service feature; and
wherein in response to receiving the selections, the processing unit transmits to the content display device one or more of: a previously recorded instance of content stored within the processing unit, programming information for at least one instance of content previously recorded and stored within the processing unit, programming information for at least one instance of content to be recorded and stored within the processing unit, and programming information for at least one instance of content available to be recorded and stored within the processing unit.

14. The system of claim 13, wherein the communications unit transmits the on screen display content as an overlay to content transmitted by the communications unit to the content display device.

15. The system of claim 13, wherein the processing unit dynamically modifies the information on the stored content service feature based on receiving selections associated with one of the plurality of programming channels capable of being recorded utilizing the stored content service feature.

16. The system of claim 13, wherein the processing unit generates the on screen display content as an electronic programming guide including a grid of a plurality of programming channels and timeframes and blocks within the grid identifying programming information for a plurality of instances of content, wherein the processing unit incorporates the information on the stored content service feature within the grid.

17. The system of claim 16, wherein the processing unit dynamically modifies the information on the stored content service feature based on receiving selections associated with the electronic programming guide.

18. The system of claim 16, wherein the processing unit transmits the information on the stored content service feature incorporated within the grid based on the processing unit determining that a timeframe for the electronic programming guide falls within a predefined time range.

19. The system of claim 18, wherein the processing unit transmits the information on the stored content service feature incorporated within the grid based on the processing unit determining that one or more instances of content associated with one or more programming channels within the electronic programming guide are capable of being recorded utilizing the stored content service feature.

20. The system of claim 16, wherein the processing unit transmits the information on the stored content service feature incorporated within the grid based on the processing unit determining that one or more instances of content associated with one or more programming channels within the electronic programming guide are capable of being recorded utilizing the stored content service feature.
